(19) United States
(12) Patent Application Publication
(10) Pub. No.: US 2026/0239229 A1
(43) Pub. Date: Aug. 13, 2026

(54) METHOD AND APPARATUS FOR POWER CONTROL WITH SIDELINK POSITIONING REFERENCE SIGNAL TRANSMISSION

(71) Applicant: MEDIATEK INC., Hsinchu City (TW)

(72) Inventor: Chiao-Yao CHUANG, Hsinchu City (TW)

(21) Appl. No.: 19/153,699

(22) PCT Filed: Feb. 6, 2024
(86) PCT No.: PCT/CN2024/076321

§ 371 Date: Aug. 5, 2025

Related U.S. Application Data
(60) Provisional application No. 63/484,211, filed on Feb. 10, 2023.
(60) Provisional application No. 63/485,016, filed on Feb. 15, 2023.

(51) Int. Cl. H04W 52/32; H04W 52/24; H04W 52/38

(52) U.S. Cl. CPC H04W 52/325; H04W 52/242; H04W 52/383

(57) ABSTRACT

Examples pertaining to an apparatus (e.g., a user equipment (UE)) for a power control with a sidelink (SL) positioning reference signal (PRS) transmission are described. A first apparatus transmits a first SL PRS to a second apparatus with a first transmission power. The first apparatus receives first reference signal received power (RSRP) information associated with the first SL PRS from the second apparatus. The first apparatus determines a first pathloss between the first apparatus and the second apparatus based on the first transmission power and the first RSRP information. The first apparatus applies the first pathloss in the power control for subsequent transmissions.

### CROSS REFERENCE TO RELATED PATENT APPLICATION(S)

The present disclosure is part of a non-provisional application claiming the priority benefit of U.S. Patent Application No. 63/484,211, filed 10 Feb. 2023, and U.S. Patent Application No. 63/485,016, filed 15 Feb. 2023. The contents of aforementioned applications are herein incorporated by reference in their entirety.

### TECHNICAL FIELD

The present disclosure is generally related to mobile communications and, more particularly, to a power control with a sidelink (SL) positioning reference signal (PRS) transmission.

### BACKGROUND

Unless otherwise indicated herein, approaches described in this section are not prior art to the claims listed below and are not admitted as prior art by inclusion in this section.

In a fourth generation (4G) Long-Term Evolution (LTE) system or a fifth generation (5G) New Radio (NR) system, SL communication (e.g., vehicle-to-vehicle (V2V) communication or vehicle-to-everything (V2X) communication) is supported which allows a direct link to be established between multiple user equipments (UEs). Specifically, in SL communication, UEs can exchange information/data directly with each other with or without intervention by a base station (BS). When one UE is within the coverage of one network system (e.g., in the coverage of one BS), the SL communication can be operated under the control of the network system. Alternatively, the SL communication can be operated independently when no cellular system is present (e.g., the UE is out of the coverage of any BS) based on some pre-configured resources.

However, when performing SL communication via a SL interface (e.g., PC5 interface), there are some issues in UE operations. For example, when one UE (e.g., UE-A) is (pre)configured with SL resource(s) to initiate the SL communication with another UE (e.g., UE-B), it is unclear how to determine a transmission power for the UE-A and the UE-B to transmit a SL PRS or other signal(s) for the first time. In addition, based on different types of SL communication, e.g., broadcast, groupcast and unicast SL communications, there is no clear guidance how to determine or adjust the transmission power for the UEs involved in different types of SL communication.

Therefore, there is a need to propose solutions to solve these issues.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

One objective of the present disclosure is to propose solutions or schemes that address the aforementioned issues pertaining to a power control with a SL PRS transmission. It is believed that the above-described issues would be avoided or otherwise alleviated by implementing one or more of the proposed schemes described herein.

In one aspect, a method may involve a processor of a first apparatus transmitting a first SL PRS to a second apparatus with a first transmission power. In response, the method may involve the processor receive first RSRP information associated with the first SL PRS from the second apparatus. The method may also involve the processor determining a first pathloss between the first apparatus and the second apparatus based on the first transmission power and the first RSRP information. The method may also involve the processor applying the first pathloss in a power control for subsequent transmissions.

In another aspect, a method may involve a processor of a second apparatus receive from a first apparatus a first SL PRS. In response, the method may involve the processor transmitting first RSRP information associated with the first SL PRS to the first apparatus.

It is noteworthy that, although description provided herein may be in the context of certain radio access technologies, networks and network topologies such as 5GS and 4G EPS mobile networking, the proposed concepts, schemes and any variation(s)/derivative(s) thereof may be implemented in, for and by other types of wireless and wired communication technologies, networks and network topologies such as, for example and without limitation, Ethernet, Universal Terrestrial Radio Access Network (UTRAN), E-UTRAN, Global System for Mobile communications (GSM), General Packet Radio Service (GPRS)/Enhanced Data rates for Global Evolution (EDGE) Radio Access Network (GERAN), Long-Term Evolution (LTE), LTE-Advanced, LTE-Advanced Pro, IoT, Industrial IoT (IIoT), Narrow Band Internet of Things (NB-IoT), and any future-developed networking technologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example network system in accordance with an implementation of the present disclosure.

FIGS. 2A to 2G illustrate example scenarios based on a first scheme for SL communication in accordance with an implementation of the present disclosure.

FIG. 3 is a diagram of another example network system in accordance with an implementation of the present disclosure.

FIGS. 4A to 4B illustrate example scenarios based on a second scheme for SL communication in accordance with an implementation of the present disclosure.

FIG. 5 illustrates another example communication system having at least an example communication apparatus and an example network apparatus in accordance with an implementation of the present disclosure.

FIG. 6 illustrates an example process in accordance with an implementation of the present disclosure.

FIG. 7 illustrates another example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to a power control with a SL PRS transmission. According to the present disclosure, a number of possible solutions may be implemented separately or jointly. That is, although these possible solutions may be described below separately, two or more of these possible solutions may be implemented in one combination or another.

In a 4G LTE system and/or a 5G NR system, SL communication (e.g., V2V communication and V2X communication) is supported which allows a direct link to be established between multiple UEs. Specifically, in SL communication, UEs can exchange information/data directly with each other with or without intervention by a BS. When one UE is within the coverage of one network system (e.g., in the coverage of one BS), the SL communication can be operated under the control of the network system. Alternatively, the SL communication can be operated independently when no network system is present (i.e., the UE is out of the coverage of any BS) based on some pre-configured resources. In addition, the SL communication includes a sensing mechanism to sense whether available physical resource(s) may be occupied, and multiple UEs within the same coverage can share information therein.

In addition, the PRS is one specific reference signal (RS) that is introduced to support single/multiple cell and device-based positioning in the 4G LTE/ 5 G NR network system. Specifically, the PRS may include a downlink (DL) PRS, which is used as DL signaling transmitted from one BS to one UE, and a SL PRS, which is used between two UEs. While utilizing the DL/SL PRS between the BS (or UE) and UE, some techniques such as round trip time (RTT), angle of arrival/departure (AoA/AoD) and time difference of arrival (TDOA) are also applied with returning measurement report for the BS/UE to estimate relevant position information in the network system.

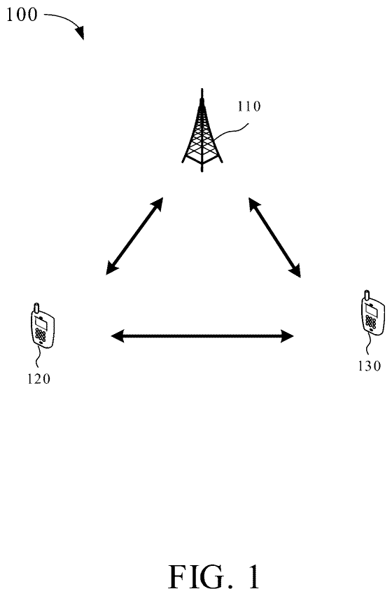

FIG. 1 is a diagram of an example network system 100 in accordance with an implementation of the present disclosure. As shown in FIG. 1, the network system 100 may be a first scheme for SL communication to include a BS 110 and at least two UEs, e.g., UE-A 120 and UE-B 130. Specifically, the BS 110 may be an evolved NodeB (eNB), a next generation NodeB (gNB), a transmission and reception point (TRP) and/or a satellite. Based on different scenarios, UE-A 120 and/or UE-B 130 may be in the coverage or out of the coverage of the BS 110. In an event that the UE-A 120 and/or the UE-B 130 is/are served by the BS 110 (i.e., in the coverage of the BS 110), the BS 110 may adaptively configure SL configuration(s) for the UE-A 120 and/or the UE-B 130, such that the UE-A 120 and/or the UE-B 130 can perform SL communication with each other. In an event that the UE-A 120 and/or the UE-B 130 is/are not served by the BS 110 (i.e., out of the coverage of the BS 110), the UE-A 120 and/or the UE-B 130 may utilize pre-configured configuration(s) to perform SL communication therebetween.

When performing SL communication via a SL interface (e.g., PC5 interface) between at least two UEs (e.g., the UE-A 120 and the UE-B 130), there are some issues in UE operations. For example, when one UE (e.g., the UE-A 120) is (pre)configured with SL configuration(s) to initiate the SL communication with another UE (e.g., the UE-B 130), it is unclear how to determine a transmission power for the UE-A 120 and the UE-B 130 to transmit a SL PRS or other signal(s) for the first time. In addition, based on different types of SL communication, e.g., broadcast, groupcast and unicast communications, there is no clear guidance how to determine or adjust the transmission power for the UEs involved in different types of SL communication. As that, some proposed solutions below are introduced to solves these issues.

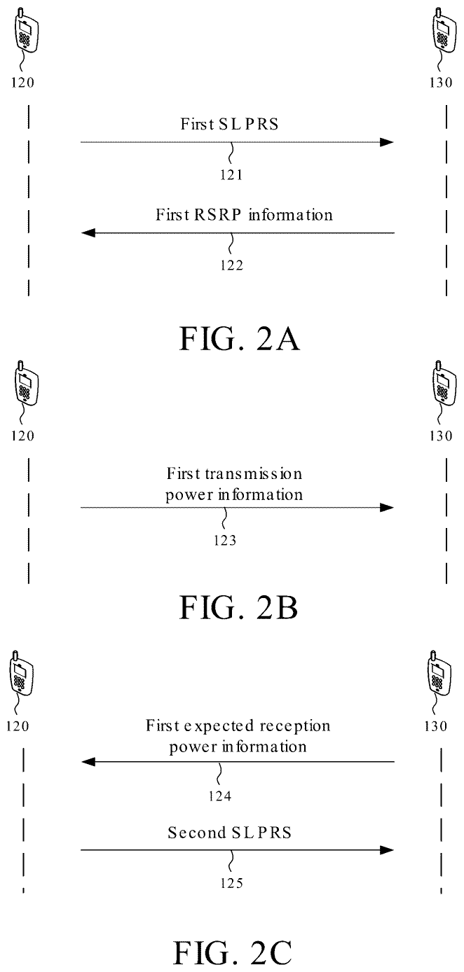

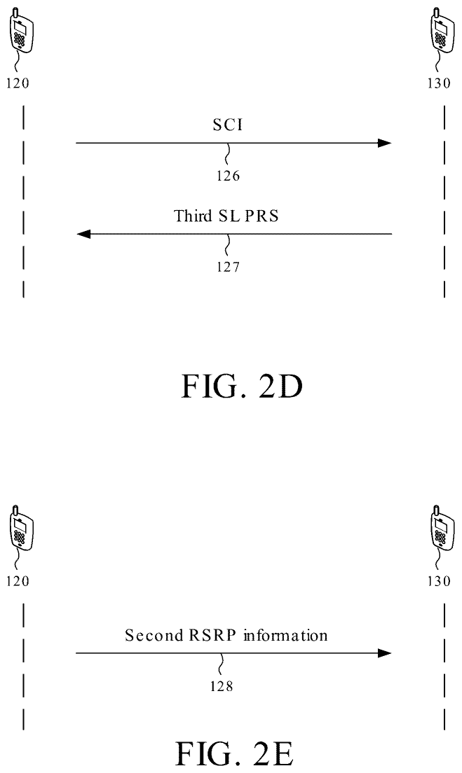

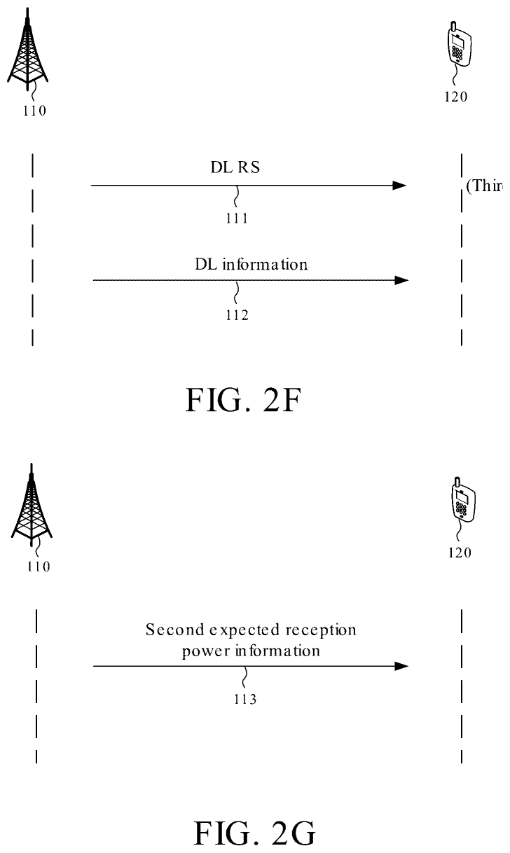

FIGS. 2A to 2G illustrate example scenarios based on a first scheme for SL communication in accordance with an implementation of the present disclosure. In the first scheme of the network system 100, for brevity, only two UEs (e.g., the UE-A 120 and the UE-B 130) are depicted in FIGS. 2A to 2E, and only one BS (e.g., the BS 110) and one UE (e.g., the UE-A 120) are depicted in FIGS. 2F to 2G. In some implementations, the BS (e.g., the BS 110) may adaptively (pre)configure SL configuration(s) to at least one UE (e.g., the UE-A 120 and/or the UE-B 130), and the SL configuration(s) may include a dedicated resource set for the UE-A 120 and/or the UE-B 130 to perform SL communication therebetween.

As shown in FIGS. 2A to 2E, the UE-A 120 is a transmission (TX) UE that initiates the SL communication, and the UE-B 130 is a reception (RX) UE that responds to the SL communication initiated by the TX UE (i.e., the UE-A 120). Likewise, the UE-B 130 can also be a TX UE to initiate the SL communication with the UE-A 120 (i.e., the UE-A 120 being the RX UE), which is not limited hereinafter. In addition, as shown in FIG. 2F and FIG. 2G, only the UE-A 120 is depicted to communicate with the BS 110; alternatively, the UE-A 120 can be replaced by the other UE (e.g., the UE-B 130) for performing similar operations, which is also within the scope of the embodiments.

In some implementations, as shown in FIG. 2A, the UE-A 120 may transmit a first SL PRS 121 to the UE-B 130 with a first UE-A transmission power. In response, the UE-B 130 may transmit first RSRP information 122 that indicates a first RSRP associated with the first SL PRS 121 to the UE-A 120. After receiving the first RSRP information 122 indicating the first RSRP from the UE-B 130, the UE-A 120 may determine a first pathloss between the UE-A 120 and the UE-B 130 based on the first UE-A transmission power and the first RSRP. As that, the UE-A 120 may apply the first pathloss in a power control for subsequent transmissions (e.g., subsequent SL PRS transmissions or other SL transmissions to the UE-B 130).

Specifically, as demonstrated in the first scheme for the SL communication (e.g., unicast communication), the SL-PRS based power control may be advantageous due to the SL PRS having a larger bandwidth when compared to other types of reference signals, which allows the receiver (e.g., the UE-B 130) to perform RSRP measurement more efficiently. Also, the first SL PRS 121 as a pseudo reference sequence/gold sequence may be randomly scrambled by the UE-A 120 in advance, which may provide better protection in view of secure concerns.

In some implementations, the first RSRP information 122 in FIG. 2A may be transmitted via one of a (pre)configured signaling, a dedicated signaling, a higher layer signaling and other types of signaling, which is not limited hereinafter. In some implementations, the first RSRP associated with the first SL PRS 121 may be obtained by filtering measurement results from the first SL PRS 121 transmitted from the UE-A 120 at the UE-B 130. Specifically, the first RSRP associated with the first SL PRS 121 may defined as a linear average over power contributions on at least one resource element that is used to carry the first SL PRS 121 configured for RSRP measurements within the configured frequency bandwidth.

After the UE-B 130 receives the first SL PRS 121 from the UE-A 120, UE-B 130 may obtain a reception power (i.e., the first RSRP) associated with the first SL PRS 121 from the UE-A 120. Next, the UE-B 130 may report the reception power (i.e., the first RSRP) as a measurement report to the UE-A 120. Then, the UE-A 120 may compute a first difference between the first UE-A transmission power and the first RSRP, so as to determine the first pathloss (i.e., first difference) between the UE-A 120 and the UE-B 130. Accordingly, the first pathloss in FIG. 2A may be applied in the power control for subsequent SL PRS transmissions or other SL transmissions. In some implementations, the UE-A 120 may indicate the first pathloss to the UE-B 130 for further SL communication (e.g., SL PRS transmissions) therebetween.

In some implementations, as shown in FIG. 2B, the UE-A 120 may further transmit first transmission power information 123 that indicates the first UE-A transmission power used by the UE-A 120 to the UE-B 130. Specifically, the first transmission power information 123 in FIG. 2B may be transmitted via one of a (pre)configured signaling, a dedicated signaling, a (SL) PRS and other types of signaling, which is not limited hereinafter.

After the UE-B 130 obtains the first UE-A transmission power utilized by the UE-A 120, the UE-B may compute a second difference between the first UE-A transmission power (indicated by the first transmission power information 123) and the reception power of the first SL PRS 121 (i.e., the first RSRP). Accordingly, the UE-B 130 may determine a second pathloss (i.e., the second difference) between the UE-A 120 and the UE-B 130, where the second difference may be substantially equal to or approximate to the first difference computed by the UE-A 120. In some implementations, the UE-B 130 may indicate the second pathloss to the UE-A 120 for further SL communication (e.g., SL PRS transmissions) therebetween.

In some implementations, as shown in FIG. 2C, the UE-B 130 may further transmit first expected reception power information 124 that indicates a UE-B expected reception power at the UE-B 130 to the UE-A 120. Specifically, the first expected reception power information 124 in FIG. 2C may be transmitted via one of a (pre)configured signaling, a dedicated signaling, a (SL) PRS and other types of signaling, which is not limited hereinafter.

In some implementations, as shown in FIG. 2A and FIG. 2C, based on the first pathloss and the UE-B expected reception power at the UE-B 130, the UE-A 120 may perform the power control to determine a second UE-A transmission power for a second SL PRS 125 to be transmitted from the UE-A 120 to the UE-B 130. In other words, UE-A 120 may utilize both the first pathloss and the UE-B expected reception power indicated by the UE-B 130 to adjust the first UE-A transmission power, so as to transmit the second SL PRS 125 with the second UE-A transmission power.

In some implementations, as shown in FIG. 2D, in an event that the UE-A 120 initiates a SL RTT positioning procedure to the UE-B 130, the UE-A 120 may further transmit SL control information (SCI) 126 to the UE-B 130. Specifically, the SCI 126 may include an SL-PRS request. After receiving the SCI 126 including the SL-PRS request, the UE-B 130 may transmit a third SL PRS 127 to the UE-A 120. In other words, the UE-A 120 may trigger the SL RTT positioning procedure via the SL-PRS request to the UE-B 130. Next, the UE-B 130 may respond to the SL RTT positioning procedure by transmitting the third SL PRS 127 to the UE-A 120.

In some implementations, the UE-B 130 may transmit the third SL PRS 127 with a UE-B transmission power. Specifically, the UE-B transmission power may be determined by UE-B 130 itself based on some values provided by UE-A 120 via one of a (pre)configured signaling, a dedicated signaling, a higher layer signaling and other types of signaling, which is not limited hereinafter.

In some implementations, as shown in FIG. 2D and FIG. 2E, after the UE-A 120 receives the third SL PRS 127 with the UE-B transmission power from the UE-B 130, the UE-A 120 may obtain second RSRP information 128 that indicates a reception power (e.g., a second RSRP) associated with the third SL PRS 127. Next, the UE-A 120 may transmit the second RSRP information 128 indicating the second RSRP to the UE-B 130. Specifically, the second RSRP information 128 may be transmitted via one of a (pre)configured signaling, a dedicated signaling, a higher layer signaling and other types of signaling, which is not limited hereinafter.

In some implementations, the second RSRP may be obtained by the UE-A 120 that filters the third SL PRS 127 transmitted from the UE-B 130. In addition, the second RSRP associated with the third SL PRS 127 may be defined as a linear average over power contributions on at least one resource element that is used to carry the third SL PRS 127 configured for RSRP measurements within the configured frequency bandwidth.

In some implementations, after the UE-B 130 receives the second RSRP information 128 indicating the second RSRP from the UE-A 120, the UE-B 130 may compute a third difference between the UE-B transmission power and the second RSRP, so as to determine a third pathloss (i.e., third difference) between the UE-A 120 and the UE-B 130. In some implementations, the UE-B 130 may indicate the third pathloss to the UE-A 120 for further SL communication (e.g., SL PRS transmissions) therebetween.

In some implementations, in an event that there is no reference pathloss for a first/initial SL transmission initiated by one UE (e.g., the UE-A 120) and it is assumed that a similar transmission condition exists between the SL communication and the DL communication, the UE may refer to an available DL pathloss with the BS (e.g., the BS 110). As shown in FIG. 2F, the BS 110 may transmit a DL RS 111 to the UE-A 120 for pathloss measurement. In addition, the BS 110 may transmit DL information 112 that indicates a BS transmission power used by the BS 110 to the UE-A 120. Specifically, the DL information 112 may be transmitted via a higher layer signaling and/or other types of signaling, which is not limited hereinafter.

After receiving the DL RS 111 and the DL information 112 indicating the BS transmission power, the UE-A 120 may determine a third RSRP as a reception power at the UE-A 120. In some implementations, the third RSRP associated with the DL RS 111 may be obtained by filtering measurement results from the DL RS 111 transmitted from the BS 110 at the UE-A 120. Accordingly, the UE-A 120 may compute a fourth difference between the BS transmission power and the third RSRP, so as to determine a DL pathloss (i.e., fourth difference) between the BS 110 and the UE-A 120. In addition, the UE-A 120 may utilize the DL pathloss to determine the first UE-A transmission power for transmitting the first/initial SL PRS transmission (e.g., the first SL PRS 121 in FIG. 2A) to the UE-B 130.

In some implementations, as shown in FIG. 2G, the BS 110 may transmit second expected reception power information 113 that indicates a BS expected reception power to the UE-A 120. Specifically, the second expected reception power information 113 may be transmitted via one of a (pre)configured signaling, a dedicated signaling, a higher layer signaling and/or other types of signaling, which is not limited hereinafter. In addition, the UE-A 120 may determine the first UE-A transmission power further based on the BS expected reception power and the DL pathloss, so as to transmit the first/initial SL PRS (e.g., the first SL PRS 121 in FIG. 2A) to the UE-B 130. In some implementations, the UE-A 120 may also consider additional factor(s) (e.g., transmission bandwidth of the SL PRS) for determining the first UE-A transmission power, which is not limited hereinafter.

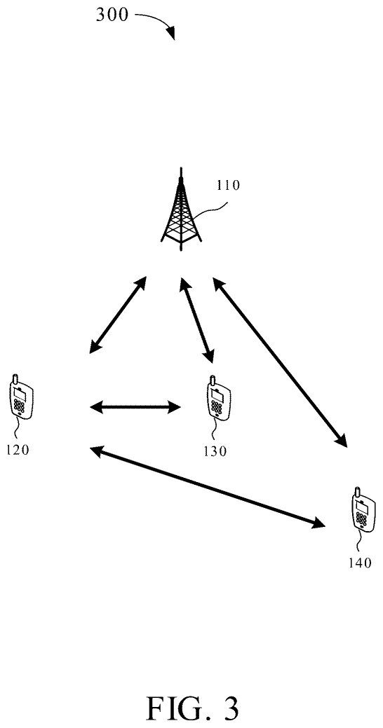

FIG. 3 is a diagram of another example network system 300 in accordance with an implementation of the present disclosure. In comparison with the first scheme of the network system 100 (including the BS 110, the UE-A 120 and the UE-B 130) in FIG. 1, the network system 300 may be a second scheme that includes the BS 110, the UE-A 120, the UE-B 130 and additional UE-C 140 for implementing different types of SL communication (e.g., a groupcast communication). Also, the BS 110 in the network system 300 may adaptively (pre)configure SL configuration(s) for the UE-A 120, the UE-B 130 and/or the UE-C 140, so as to support the groupcast communication.

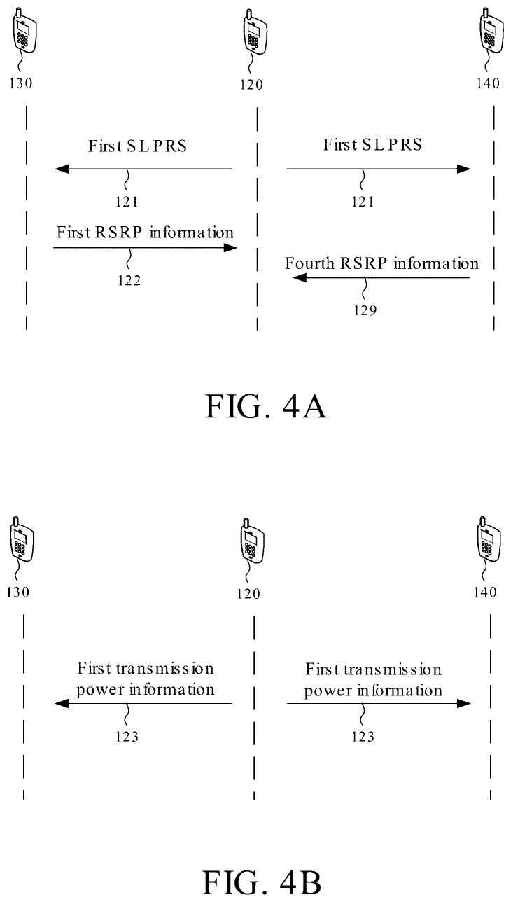

FIGS. 4A and 4B illustrate example scenarios based on a second scheme for SL communication in accordance with an implementation of the present disclosure. In the second scheme of the network system 300, as shown in FIG. 3, FIGS. 4A and 4B, the UE-B 130 and the UE-C 140 may be configured in the coverage of the UE-A 120 to share relevant SL information by the sensing mechanism. In some implementations, based on the (pre)configured SL configuration(s) by the BS 110, the UE-A 120 may initiate a groupcast procedure to the UE-B 130 and the UE-C 140 for at least one time. In some implementations, the UE-A 120 may also individually initiate a unicast procedure with the UE-B 130 and/or the UE-C 140 for SL communication (e.g., SL PRS transmissions), and detailed operations are similar to the implementations shown from FIGS. 2A to 2G, which may be neglected hereinafter for brevity.

In some implementations, as shown in FIG. 4A, after the UE-A 120 initiates the groupcast procedure with the UE-B 130 and UE-C 140, the UE-A 120 may simultaneously transmit the first SL PRS 121 to the UE-B 130 and to the UE-C 140. In response, during the same groupcast procedure or in different unicast/groupcast procedure(s), the UE-B 130 and the UE-C 140 may individually transmit their RSRPs to the UE-A 120.

Being similar to the implementations in FIG. 2A, the UE-B 130 may transmit the first RSRP information 122 indicating the first RSRP to the UE-A 120, and the UE-C may transmit fourth RSRP information 129 that indicates a fourth RSRP to the UE-A 120. In some implementations, the fourth RSRP information 129 may be transmitted via one of a (pre)configured signaling, a dedicated signaling, a higher layer signaling and other types of signaling, which is not limited hereinafter. In some implementations, the fourth RSRP associated with the first SL PRS 121 may be obtained by filtering measurement results from the first SL PRS 121 transmitted from the UE-A 120 at the UE-C 140.

After receiving the first RSRP information 122 from the UE-B 130 and receiving the fourth RSRP information 129 from the UE-C 140, the UE-A 120 may determine its pathloss with the UE-B 130 and the UE-C 140 for the SL communication. Since detailed implementations of determining the pathloss for SL PRS transmissions may be similar to the implementations shown from FIGS. 2A to 2G, which may be neglected hereinafter for brevity.

In some implementations, as shown in FIG. 4B, during the same groupcast procedure initiated by the UE-A 120, the UE-A 120 may simultaneously transmit the first transmission power information 123 that indicates the first UE-A transmission power to both the UE-B 130 and the UE-C 140. Alternatively, the UE-A 120 may individually transmit the first transmission power information 123 to the UE-B 130 and the UE-C 140 via different unicast/groupcast procedure(s), which is not limited hereinafter.

In some implementations, being similar to the implementations of determining the pathloss in FIG. 2B at the UE-B 130, after the UE-C 140 receives the first transmission power information 123 indicating the first UE-A transmission power, the UE-C 140 may compute a fifth difference between the first UE-A transmission power and a reception power of the first SL PRS 121 (i.e., the fourth RSRP), so as to determine a fourth pathloss (i.e., the fifth difference) between the UE-A 120 and the UE-C 140. In some implementations, the UE-C 140 may indicate the fourth pathloss to the UE-A 120 for further SL communication (e.g., SL PRS transmissions) therebetween.

In view of the above two schemes for different types of SL communications (e.g., unicast communication and groupcast communication), the SL PRS and the corresponding RSRP information are communicated between at least two UEs (e.g., UE-A and UE-B) for adaptively determining the pathloss for SL PRS transmissions. Also, by introducing different information indicating the transmission power, the expected reception power and the DL pathloss/information, the pathloss for SL PRS transmissions may be efficiently determined for a better power control in different types of SL communications.

### Illustrative Implementations

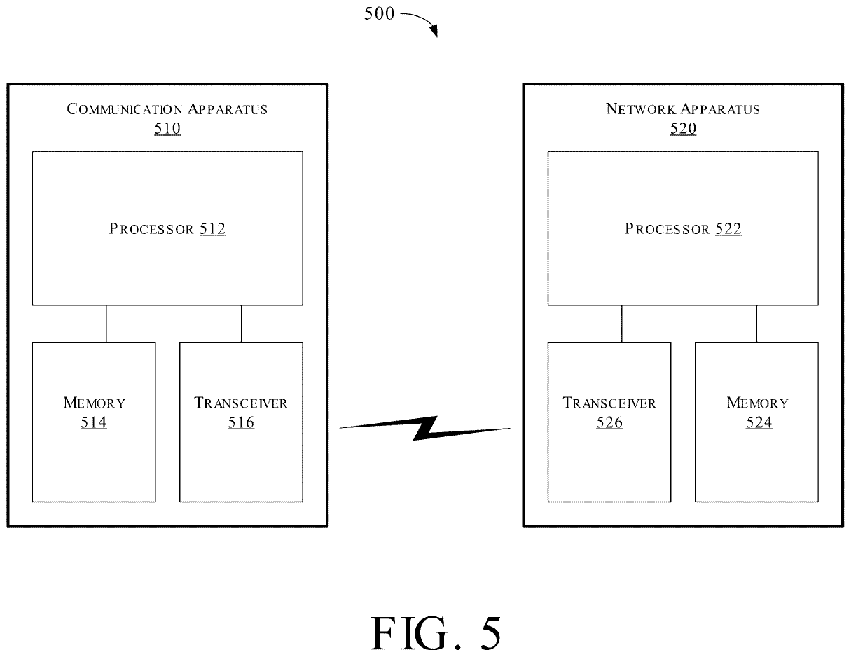

FIG. 5 illustrates an example communication system 500 having at least an example communication apparatus 510 and an example network apparatus 520 in accordance with an implementation of the present disclosure. Each of apparatus 510 and apparatus 520 may perform various functions to implement schemes, techniques, processes and methods described herein pertaining to a power control with a SL PRS transmission, including the various schemes described above with respect to various proposed designs, concepts, schemes, systems and methods described above, including network systems 100 and 300, as well as processes described below.

Each of apparatus 510 and apparatus 520 may be a part of an electronic apparatus, which may be a network apparatus or a UE (e.g., the UE-A 120, the UE-B 130 and the UE-C 140), such as a portable or mobile apparatus, a wearable apparatus, a vehicular device or a vehicle, a wireless communication apparatus or a computing apparatus. For instance, each of apparatus 510 and apparatus 520 may be implemented in a smartphone, a smart watch, a personal digital assistant, an electronic control unit (ECU) in a vehicle, a digital camera, or a computing equipment such as a tablet computer, a laptop computer or a notebook computer. Each of apparatus 510 and apparatus 520 may also be a part of a machine type apparatus, which may be an IoT apparatus such as an immobile or a stationary apparatus, a home apparatus, a roadside unit (RSU), a wire communication apparatus or a computing apparatus. For instance, each of apparatus 510 and apparatus 520 may be implemented in a smart thermostat, a smart fridge, a smart door lock, a wireless speaker or a home control center. When implemented in or as a network apparatus, apparatus 510 and/or apparatus 520 may be implemented in an eNB in an LTE, LTE-Advanced or LTE-Advanced Pro network or in a gNB, a satellite, a repeater or TRP in a 5G network, an NR network or an IoT network.

In some implementations, each of apparatus 510 and apparatus 520 may be implemented in the form of one or more integrated-circuit (IC) chips such as, for example and without limitation, one or more single-core processors, one or more multi-core processors, one or more complex-instruction-set-computing (CISC) processors, or one or more reduced-instruction-set-computing (RISC) processors. In the various schemes described above, each of apparatus 510 and apparatus 520 may be implemented in or as a network apparatus or a UE. Each of apparatus 510 and apparatus 520 may include at least some of those components shown in FIG. 5 such as a processor 512 and a processor 522, respectively, for example. Each of apparatus 510 and apparatus 520 may further include one or more other components not pertinent to the proposed scheme of the present disclosure (e.g., internal power supply, display device and/or user interface device), and, thus, such component(s) of apparatus 510 and apparatus 520 are neither shown in FIG. 5 nor described below in the interest of simplicity and brevity.

In one aspect, each of processor 512 and processor 522 may be implemented in the form of one or more single-core processors, one or more multi-core processors, or one or more CISC or RISC processors. That is, even though a singular term “a processor” is used herein to refer to processor 512 and processor 522, each of processor 512 and processor 522 may include multiple processors in some implementations and a single processor in other implementations in accordance with the present disclosure. In another aspect, each of processor 512 and processor 522 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 512 and processor 522 is a special-purpose machine specifically designed, arranged and configured to perform specific tasks including those pertaining to a power control with a SL PRS transmission in accordance with various implementations of the present disclosure.

In some implementations, apparatus 510 may also include a transceiver 516 coupled to processor 512. Transceiver 516 may be capable of wirelessly transmitting and receiving data. In some implementations, transceiver 516 may be capable of wirelessly communicating with different types of wireless networks of different radio access technologies (RATs). In some implementations, transceiver 516 may be equipped with a plurality of antenna ports (not shown) such as, for example, four antenna ports. That is, transceiver 516 may be equipped with multiple transmit antennas and multiple receive antennas for multiple-input multiple-output (MIMO) wireless communications. In some implementations, apparatus 520 may also include a transceiver 526 coupled to processor 522. Transceiver 526 may include a transceiver capable of wirelessly transmitting and receiving data. In some implementations, transceiver 526 may be capable of wirelessly communicating with different types of UEs/wireless networks of different RATs. In some implementations, transceiver 526 may be equipped with a plurality of antenna ports (not shown) such as, for example, four antenna ports. That is, transceiver 526 may be equipped with multiple transmit antennas and multiple receive antennas for MIMO wireless communications.

In some implementations, apparatus 510 may further include a memory 514 coupled to processor 512 and capable of being accessed by processor 512 and storing data therein. In some implementations, apparatus 520 may further include a memory 524 coupled to processor 522 and capable of being accessed by processor 522 and storing data therein. Each of memory 514 and memory 524 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 514 and memory 524 may include a type of read-only memory (ROM) such as mask ROM, programmable ROM (PROM), erasable programmable ROM (EPROM) and/or electrically erasable programmable ROM (EEPROM). Alternatively, or additionally, each of memory 514 and memory 524 may include a type of non-volatile random-access memory (NVRAM) such as flash memory, solid-state memory, ferroelectric RAM (FeRAM), magnetoresistive RAM (MRAM) and/or phase-change memory. Alternatively, or additionally, each of memory 514 and memory 524 may include a UICC.

Each of apparatus 510 and apparatus 520 may be a communication entity capable of communicating with each other using various proposed schemes in accordance with the present disclosure. For illustrative purposes and without limitation, a description of capabilities of apparatus 510, as a UE (e.g., the UE-A 120, the UE-B 130 and the UE-C 140) and/or a network node (e.g., the BS 110) of a wireless network, is provided below.

Under certain proposed schemes in accordance with the present disclosure with respect to a power control with a SL PRS transmission, processor 512 of a first apparatus 510, implemented in or as UE-A 120, may transmit, via transceiver 516, a first SL PRS to a second apparatus, implemented in or as UE-B 130, with a first transmission power. Additionally, processor 512 may receive first RSRP information associated with the first SL PRS from the second apparatus implemented in or as UE-B 130. Additionally, processor 512 may determine a pathloss between the first apparatus (e.g., the UE-A 120) and the second apparatus (e.g., the UE-B 130) based on the first transmission power and the first RSRP information. Additionally, processor 512 may apply the first pathloss in a power control for subsequent transmissions.

In some implementations, the first RSRP information is obtained by filtering measurement results from the first SL PRS transmitted from the first apparatus (e.g., the UE-A 120).

In some implementations, processor 512 may transmit first transmission power information indicating the first transmission power to the second apparatus (e.g., the UE-B 130).

In some implementations, processor 512 may receive first expected reception power information from the second apparatus (e.g., the UE-B 130). In some implementations, the power control may include determining a second transmission power for a second SL PRS to the second apparatus (e.g., the UE-B 130) based on the first pathloss and the first expected reception power information.

In some implementations, processor 512 may transmit a SCI to the second apparatus (e.g., the UE-B 130), where the SCI may include an SL-PRS request. Additionally, processor 512 may receive a third SL PRS from the second apparatus (e.g., the UE-B 130).

In some implementations, processor 512 may transmit second RSRP information associated with the third SL PRS to the second apparatus (e.g., the UE-B 130).

In some implementations, processor 512 may receive a DL RS from a network node (e.g., the BS 110) and receive DL information indicating a DL transmission power used by the network node (e.g., the BS 110). In response, processor 512 may determine a second pathloss between the first apparatus (e.g., the UE-A 120) and the network node (e.g., the BS 110) based on the DL transmission power and third RSRP information associated with the DL RS. Additionally, processor 512 may determine the first transmission power based on the second pathloss.

In some implementations, processor 512 may receive second expected reception power information from the network node (e.g., the BS 110), where the first transmission power is determined further based on the second expected reception power information.

In some implementations, processor 512 may initiate a groupcast procedure to transmit the first SL PRS to the second apparatus (e.g., the UE-B 130) and a third apparatus (e.g., the UE-C 140). Additionally, processor 512 may receive fourth RSRP information associated with the first SL PRS from the third apparatus (e.g., the UE-C 140).

In some implementations, processor 512 may transmit first transmission power information indicating the first transmission power to the second apparatus (e.g., the UE-B 130) and the third apparatus (e.g., the UE-C 140).

Under certain proposed schemes in accordance with the present disclosure of a power control with a SL PRS transmission, processor 512 of a second apparatus 510, implemented in or as UE-B 130, may receive from a first apparatus, implemented in or as UE-A 120, a first SL PRS. Additionally, processor 512 may transmit, via transceiver 516, first RSRP information associated with the first SL PRS to the first apparatus (e.g., the UE-A 120).

In some implementations, the first RSRP information is obtained by filtering measurement results from the first SL PRS transmitted from the first apparatus (e.g., the UE-A 120).

In some implementations, processor 512 may receive first transmission power information indicating the first transmission power from the first apparatus (e.g., the UE-A 120). In response, processor 512 may determine a first pathloss between the first apparatus (e.g., the UE-A 120) and the second apparatus (e.g., the UE-B 130) based on the first RSRP information and the first transmission power. Additionally, processor 512 may apply the first pathloss in a power control for subsequent transmissions.

In some implementations, processor 512 may transmit first expected reception power information of the second apparatus (e.g., the UE-B 130) to the first apparatus (e.g., the UE-A 120). Additionally, processor 512 may receive a second SL PRS with a second transmission power from the first apparatus (e.g., the UE-A 120).

In some implementations, processor 512 may transmit a third SL PRS to the first apparatus (e.g., the UE-A 120) with a third transmission power. In response, processor 512 may receive second RSRP information associated with the third SL PRS from the first apparatus (e.g., the UE-A 120). Additionally, processor 512 may determine a first pathloss between the first apparatus (e.g., the UE-A 120) and the second apparatus (e.g., the UE-B 130) based on the third transmission power and the second RSRP information. Additionally, processor 512 may apply the first pathloss in a power control for subsequent transmissions.

In some implementations, processor 512 may receive a SCI from the first apparatus (e.g., the UE-A 120), where the SCI may include a SL-PRS request, and the third SL PRS is transmitted responsive to the SL-PRS request.

In some implementations, processor 512 may receive a DL RS transmitted from a network node (e.g., the BS 110) and DL information indicating a DL transmission power used by the network node (e.g., the BS 110). In response, processor 512 may determine a second pathloss between the second apparatus (e.g., the UE-B 130) and the network node (e.g., the BS 110) based on the DL transmission power and third RSRP information associated with the DL RS. Additionally, processor 512 may determine the third transmission power based on the second pathloss.

In some implementations, processor 512 may receive second expected reception power information from the network node (e.g., the BS 110), where the third transmission power is determined further based on the second expected reception power information.

In some implementations, processor 512 may initiate a groupcast procedure to transmit the third SL PRS to the first apparatus (e.g., the UE-A 120) and a third apparatus (e.g., the UE-C 140). In response, processor 512 may receive fourth RSRP information associated with the third SL PRS from the third apparatus (e.g., the UE-C 140).

In some implementations, processor 512 may transmit third transmission power information indicating the third transmission power to the first apparatus (e.g., the UE-A 120) and the third apparatus (e.g., the UE-C 140).

### Illustrative Processes

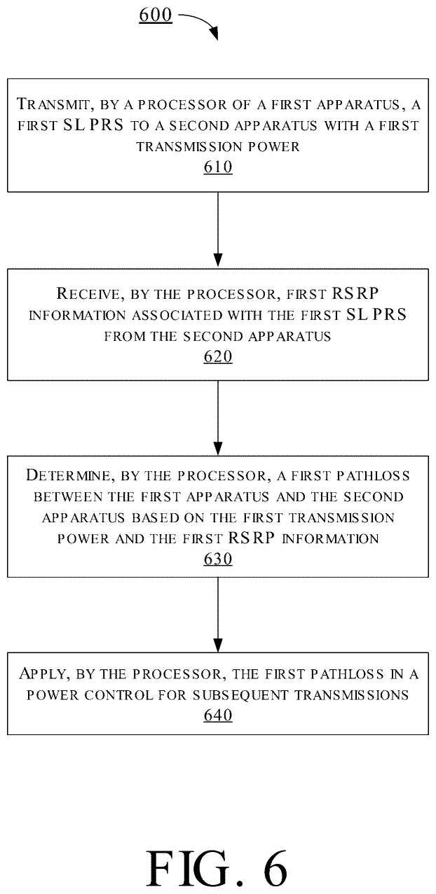

FIG. 6 illustrates an example process 600 in accordance with an implementation of the present disclosure. Process 600 may represent an aspect of implementing various proposed designs, concepts, schemes, systems and methods described above, whether partially or entirely, including those described above. More specifically, process 600 may represent an aspect of the proposed concepts and schemes pertaining to a power control with a SL PRS transmission. Process 600 may include one or more operations, actions, or functions as illustrated by one or more of blocks 610 to 640. Although illustrated as discrete blocks, various blocks of process 600 may be divided into additional blocks, combined into fewer blocks, or eliminated, depending on the desired implementation. Moreover, the blocks/sub-blocks of process 600 may be executed in the order shown in FIG. 6 or, alternatively in a different order. Furthermore, one or more of the blocks/sub-blocks of process 600 may be executed iteratively. Process 600 may be implemented by or in apparatus 510 and apparatus 520 as well as any variations thereof. Solely for illustrative purposes and without limiting the scope, process 600 is described below in the context of apparatus 510 as a UE (e.g., the UE-A 120) and apparatus 520 as a communication entity such as a network node (e.g., the BS 110) of a wireless network. Process 600 may begin at block 610.

At 610, process 600 may involve processor 512 of a first apparatus 510, implemented in or as UE-A 120, transmitting, a first SL PRS to a second apparatus (e.g., the UE-B 130) with a first transmission power. Process 600 may proceed from 610 to 620.

At 620, process 600 may involve processor 512 receiving first RSRP information associated with the first SL PRS from the second apparatus (e.g., the UE-B 130). Process 600 may proceed from 620 to 630.

At 630, process 600 may involve processor 512 determining a first pathloss between the first apparatus (e.g., the UE-A 120) and the second apparatus (e.g., the UE-B 130) based on the first transmission power and the first RSRP information. Process 600 may proceed from 630 to 640.

At 640, process 600 may involve processor 512 applying the first pathloss in a power control for subsequent transmissions.

In some implementations, the first RSRP information is obtained by filtering measurement results from the first SL PRS transmitted from the first apparatus (e.g., the UE-A 120).

In some implementations, process 600 may further involve processor 512 transmitting first transmission power information indicating the first transmission power to the second apparatus (e.g., the UE-B 130).

In some implementations, process 600 may further involve processor 512 receiving first expected reception power information from the second apparatus (e.g., the UE-B 130). In some implementations, the power control may include determining a second transmission power for a second SL PRS to the second apparatus (e.g., the UE-B 130) based on the first pathloss and the first expected reception power information.

In some implementations, process 600 may further involve processor 512 transmitting a SCI to the second apparatus (e.g., the UE-B 130), where the SCI may include an SL-PRS request. Additionally, process 600 may further involve processor 512 receiving a third SL PRS from the second apparatus (e.g., the UE-B 130).

In some implementations, process 600 may further involve processor 512 transmitting second RSRP information associated with the third SL PRS to the second apparatus (e.g., the UE-B 130).

In some implementations, process 600 may further involve processor 512 receiving a DL RS from a network node (e.g., the BS 110) and receiving DL information indicating a DL transmission power used by the network node (e.g., the BS 110). In response, process 600 may further involve processor 512 determining a second pathloss between the first apparatus (e.g., the UE-A 120) and the network node (e.g., the BS 110) based on the DL transmission power and third RSRP information associated with the DL RS. Additionally, process 600 may further involve processor 512 determining the first transmission power based on the second pathloss.

In some implementations, process 600 may further involve processor 512 receiving second expected reception power information from the network node (e.g., the BS 110), where the first transmission power is determined further based on the second expected reception power information.

In some implementations, process 600 may further involve processor 512 initiating a groupcast procedure to transmit the first SL PRS to the second apparatus (e.g., the UE-B 130) and a third apparatus (e.g., the UE-C 140). Additionally, process 600 may further involve processor 512 receiving fourth RSRP information associated with the first SL PRS from the third apparatus (e.g., the UE-C 140).

In some implementations, process 600 may further involve processor 512 transmitting first transmission power information indicating the first transmission power to the second apparatus (e.g., the UE-B 130) and the third apparatus (e.g., the UE-C 140).

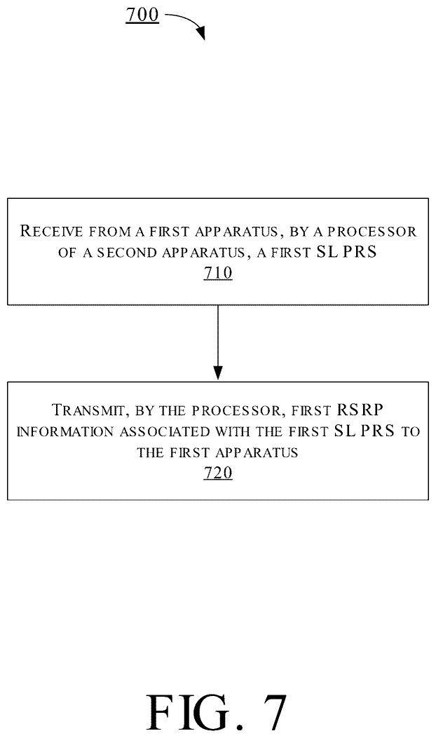

FIG. 7 illustrates another example process 700 in accordance with an implementation of the present disclosure. Process 700 may represent an aspect of implementing various proposed designs, concepts, schemes, systems and methods described above, whether partially or entirely, including those described above. More specifically, process 700 may represent an aspect of the proposed concepts and schemes pertaining to a power control with a SL PRS transmission. Process 700 may include one or more operations, actions, or functions as illustrated by block 710 to 720. Although illustrated as discrete blocks, various block of process 700 may be divided into additional blocks, combined into fewer blocks, or eliminated, depending on the desired implementation. Moreover, the blocks/sub-blocks of process 700 may be executed in the order shown in FIG. 7 or, alternatively in a different order. Furthermore, one or more of the blocks/sub-blocks of process 700 may be executed iteratively. Process 700 may be implemented by or in apparatus 510 and apparatus 520 as well as any variations thereof. Solely for illustrative purposes and without limiting the scope, process 700 is described below in the context of apparatus 510 as a UE (e.g., the UE-B 130) and apparatus 520 as a communication entity such as a network node (e.g., the BS 110) of a wireless network. Process 700 may begin at block 710.

At 710, process 700 may involve processor 512 of a second apparatus 510, implemented in or as a UE (e.g., the UE-B 130), receiving from a first apparatus (e.g., the UE-A 120) a first SL PRS. Process 700 may proceed from 710 to 720.

At 720, process 700 may involve processor 512 transmitting first RSRP information associated with the first SL PRS to the first apparatus (e.g., the UE-A 120).

In some implementations, the first RSRP information is obtained by filtering measurement results from the first SL PRS transmitted from the first apparatus (e.g., the UE-A 120).

In some implementations, process 700 may involve processor 512 receiving first transmission power information indicating the first transmission power from the first apparatus (e.g., the UE-A 120). In response, process 700 may involve processor 512 determining a first pathloss between the first apparatus (e.g., the UE-A 120) and the second apparatus (e.g., the UE-B 130) based on the first RSRP information and the first transmission power. Additionally, process 700 may involve processor 512 applying the first pathloss in a power control for subsequent transmissions.

In some implementations, process 700 may involve processor 512 transmitting first expected reception power information of the second apparatus (e.g., the UE-B 130) to the first apparatus (e.g., the UE-A 120). Additionally, process 700 may involve processor 512 receiving a second SL PRS with a second transmission power from the first apparatus (e.g., the UE-A 120).

In some implementations, process 700 may involve processor 512 transmitting a third SL PRS to the first apparatus (e.g., the UE-A 120) with a third transmission power. In response, process 700 may involve processor 512 receiving second RSRP information associated with the third SL PRS from the first apparatus (e.g., the UE-A 120). Additionally, process 700 may involve processor 512 determining a first pathloss between the first apparatus (e.g., the UE-A 120) and the second apparatus (e.g., the UE-B 130) based on the third transmission power and the second RSRP information. Additionally, process 700 may involve processor 512 applying the first pathloss in a power control for subsequent transmissions.

In some implementations, process 700 may involve processor 512 receiving a SCI from the first apparatus (e.g., the UE-A 120), where the SCI may include a SL-PRS request, and the third SL PRS is transmitted responsive to the SL-PRS request.

In some implementations, process 700 may involve processor 512 receiving a DL RS transmitted from a network node (e.g., the BS 110) and DL information indicating a DL transmission power used by the network node (e.g., the BS 110). In response, process 700 may involve processor 512 determining a second pathloss between the second apparatus (e.g., the UE-B 130) and the network node (e.g., the BS 110) based on the DL transmission power and third RSRP information associated with the DL RS. Additionally, process 700 may involve processor 512 determining the third transmission power based on the second pathloss.

In some implementations, process 700 may involve processor 512 receiving second expected reception power information from the network node (e.g., the BS 110), where the third transmission power is determined further based on the second expected reception power information.

In some implementations, process 700 may involve processor 512 initiating a groupcast procedure to transmit the third SL PRS to the first apparatus (e.g., the UE-A 120) and a third apparatus (e.g., the UE-C 140). In response, process 700 may involve processor 512 receiving fourth RSRP information associated with the third SL PRS from the third apparatus (e.g., the UE-C 140).

In some implementations, process 700 may involve processor 512 transmitting third transmission power information indicating the third transmission power to the first apparatus (e.g., the UE-A 120) and the third apparatus (e.g., the UE-C 140).

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
transmitting, by a processor of a first apparatus, a first sidelink (SL) positioning reference signal (PRS) to a second apparatus with a first transmission power;
receiving, by the processor, first reference signal received power (RSRP) information associated with the first SL PRS from the second apparatus;
determining, by the processor, a first pathloss between the first apparatus and the second apparatus based on the first transmission power and the first RSRP information; and
applying, by the processor, the first pathloss in a power control for subsequent transmissions.

2. The method of claim 1, wherein the first RSRP information is obtained by filtering measurement results from the first SL PRS transmitted from the first apparatus.

3. The method of claim 1, further comprising:
transmitting, by the processor, first transmission power information indicating the first transmission power to the second apparatus.

4. The method of claim 1, further comprising:
receiving, by the processor, first expected reception power information from the second apparatus,
wherein the power control comprises determining a second transmission power for a second SL PRS to the second apparatus based on the first pathloss and the first expected reception power information.

5. The method of claim 1, further comprising:
transmitting, by the processor, a SL control information (SCI) to the second apparatus, wherein the SCI comprises an SL-PRS request; and
receiving, by the processor, a third SL PRS from the second apparatus.

6. The method of claim 5, further comprising:
transmitting, by the processor, second RSRP information associated with the third SL PRS to the second apparatus.

7. The method of claim 1, further comprising:
receiving, by the processor, a downlink (DL) reference signal (RS) from a network node;
receiving, by the processor, DL information indicating a DL transmission power used by the network node;
determining, by the processor, a second pathloss between the first apparatus and the network node based on the DL transmission power and third RSRP information associated with the DL RS; and
determining, by the processor, the first transmission power based on the second pathloss.

8. The method of claim 7, further comprising:
receiving, by the processor, second expected reception power information from the network node,
wherein the first transmission power is determined further based on the second expected reception power information.

9. The method of claim 1, further comprising:
initiating, by the processor, a groupcast procedure to transmit the first SL PRS to the second apparatus and a third apparatus; and
receiving, by the processor, fourth RSRP information associated with the first SL PRS from the third apparatus.

10. The method of claim 9, further comprising:
transmitting, by the processor, first transmission power information indicating the first transmission power to the second apparatus and the third apparatus.

11. A method, comprising:
receiving from a first apparatus, by a processor of a second apparatus, a first sidelink (SL) positioning reference signal (PRS); and
transmitting, by the processor, first reference signal received power (RSRP) information associated with the first SL PRS to the first apparatus.

12. The method of claim 11, wherein the first RSRP information is obtained by filtering measurement results from the first SL PRS transmitted from the first apparatus.

13. The method of claim 11, further comprising:
receiving, by the processor, first transmission power information indicating the first transmission power from the first apparatus;
determining, by the processor, a first pathloss between the first apparatus and the second apparatus based on the first RSRP information and the first transmission power; and
applying, by the processor, the first pathloss in a power control for subsequent transmissions.

14. The method of claim 11, further comprising:
transmitting, by the processor, first expected reception power information of the second apparatus to the first apparatus; and
receiving, by the processor, a second SL PRS with a second transmission power from the first apparatus.

15. The method of claim 11, further comprising:
transmitting, by the processor, a third SL PRS to the first apparatus with a third transmission power;
receiving, by the processor, second RSRP information associated with the third SL PRS from the first apparatus;
determining, by the processor, a first pathloss between the first apparatus and the second apparatus based on the third transmission power and the second RSRP information; and
applying, by the processor, the first pathloss in a power control for subsequent transmissions.

16. The method of claim 15, further comprising:
receiving, by the processor, a SL control information (SCI) from the first apparatus,
wherein the SCI comprises a SL-PRS request, and the third SL PRS is transmitted responsive to the SL-PRS request.

17. The method of claim 15, further comprising:
receiving, by the processor, a downlink (DL) reference signal (RS) transmitted from a network node;
receiving, by the processor, DL information indicating a DL transmission power used by the network node;
determining, by the processor, a second pathloss between the second apparatus and the network node based on the DL transmission power and third RSRP information associated with the DL RS; and
determining, by the processor, the third transmission power based on the second pathloss.

18. The method of claim 17, further comprising:
receiving, by the processor, second expected reception power information from the network node,
wherein the third transmission power is determined further based on the second expected reception power information.

19. The method of claim 15, further comprising:
initiating, by the processor, a groupcast procedure to transmit the third SL PRS to the first apparatus and a third apparatus; and
receiving, by the processor, fourth RSRP information associated with the third SL PRS from the third apparatus.

20. The method of claim 19, further comprising:
transmitting, by the processor, third transmission power information indicating the third transmission power to the first apparatus and the third apparatus.
